(19) United States
(12) Patent Application Publication
(10) Pub. No.: US 2007/0120805 A1
(43) Pub. Date: May 31, 2007

(54) DATA DRIVER INTEGRATED CIRCUIT DEVICE, LIQUID CRYSTAL DISPLAY INCLUDING THE SAME AND METHOD OF DATA-DRIVING LIQUID CRYSTAL DISPLAY

(76) Inventor: Sang-hak Yi, Yongin-si (KR)

Correspondence Address: Frank Chau, Esq.;F. CHAU & ASSOCIATES, LLC, Suite 501, 1900 Hempstead Turnpike, East Meadow, NY, 11554, US

(21) Appl. No.: 11/560,135

(22) Filed: Nov. 15, 2006

(30) Foreign Application Priority Data
Nov. 30, 2005 (KR) 10-2005-0115849

(51) Int. Cl. G09G 3/36

(52) U.S. Cl. 345/100

(57) ABSTRACT

A data driver integrated circuit device includes a gamma decoding unit that receives differential gamma data transmitted by a timing controller and decodes the received differential gamma data, a digital-to-analog conversion (DAC) unit that converts the decoded differential gamma data into analog voltage values, land a buffer unit that amplifies the analog voltage values and outputs the amplified values.

### CROSS-REFERENCE TO RELATED PATENT APPLICATION

This application claims priority to Korean Patent Application No. 10-2005-0115849, filed on Nov. 30, 2005, the disclosure of which is herein incorporated by reference in its entirety.

### BACKGROUND OF THE INVENTION

1. Technical Field

The present disclosure relates to a liquid crystal display (LCD), and, more particularly to a data driver integrated circuit device and an LCD including the data driver integrated circuit device,

2. Discussion of Related Art

Display devices can be largely classified into self-emitting display devices, such as the cathode ray tube (CRT) type and the field emission display (FED) type, and non-emissive display devices such as liquid crystal displays (LCDs), which require a separate, external light source such as a backlight.

In general, a liquid crystal display uses a thin film transistor as a switching device and the electro-optical properties of liquid crystals to display data.

A conventional LCD employs a liquid crystal panel, a gate driver, a data driver, a driving-voltage generator? a timing controller, and a gray-scale voltage generator, Data line driver signals and gate line driver signals are applied to the liquid crystal panel.

The gray-scale voltages that are generated by the gray-scale voltage generator are applied to the data driver. To prevent capacitance coupling effects, a gray-scale voltage compensation method can be used, in which the data driver supplies a compensated gray-scale voltage.

In the conventional LCD, the gray-scale voltage generator includes a positive gray-scale voltage generator for generating positive gray-scale voltages, a negative gray-scale voltage generator for generating negative gray-scale voltages, and a voltage amplifier for amplifying the voltage and supplying the amplified voltage to the positive and negative gray-scale voltage generators.

However, since the positive and negative gray-scale voltage generators have a plurality of resistors connected in series, a variation in the gray-scale voltage may be generated due to resistance differences between the resistors. Further, since the voltage amplifier is realized using an operational amplifier (OP-AMP), the printed circuit board may become large and bulky.

### SUMMARY OF THE INVENTION

According to an exemplary embodiment of the present invention, there is provided a data driver integrated circuit device including a gamma decoding unit that receives differential gamma data transmitted by a timing controller, and decodes the received differential gamma data, a digital-to-analog conversion (DAC) unit that converts the decoded differential gamma data into analog voltage values, and a buffer unit that amplifies the analog voltage values and outputs the amplified values.

According to an exemplary embodiment of the present invention, there is provided a liquid crystal display (LCD) including a liquid crystal panel that includes a plurality of thin film transistors (TFTs), a plurality of gate lines electrically connected to gate electrodes of the plurality of TFTs, and a plurality of data lines electrically connected to source electrodes of the plurality of TFTS, a timing controller that generates control signals for controlling operations of a gate driver and a data driver integrated circuit device and provides the data driver with differential gamma data driving signals, and the data driver integrated circuit device converts the differential gamma data driving signals into analog voltage values and applies the converted values to the plurality of data lines of the liquid crystal panel.

According to an exemplary embodiment of the present invention, there is provided a method of data driving of a display. The method includes: receiving differential gamma data transmitted by a timing controller, decoding the received differential gamma data converting the decoded differential gamma data into analog voltage values; and amplifying the analog voltage values and outputting the amplified values.

### BRIEF DESCRIPTION OF THE DRAWINGS

The present invention will become readily apparent to those of ordinary skill in the art when descriptions of exemplary embodiments thereof are read with reference to the accompanying drawings.

FIG. 1 is a block diagram of a liquid crystal display (LCD) according to an exemplary embodiment of the present invention.

FIG. 2 illustrates how differential gamma data is transmitted from a timing controller to a data driver according to an exemplary embodiment of the present invention.

FIGS. 3 and 4 are diagrams showing waveforms that correspond to differential gamma data transmitted according to an exemplary embodiment of the present invention.

FIG. 5 is a block diagram of a data driver integrated circuit device according to an exemplary embodiment of the present invention.

### DESCRIPTION OF EXEMPLARY EMBODIMENTS

Hereinafter, exemplary embodiments of the present invention will be described in detail with reference to the accompanying drawings Like reference numerals refer to similar or identical elements throughout the description of the figures.

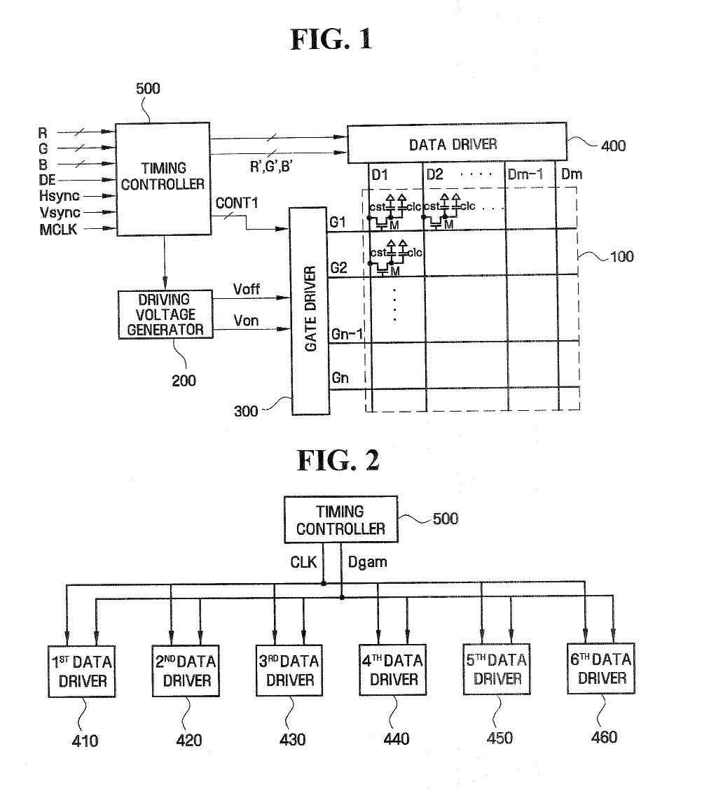

Hereinafter, a liquid crystal display (LCD) according to an exemplary embodiment of the present invention will be described with reference to FIG. 1.

FIG. 1 is a block diagram of a liquid crystal display (LCD) according to an exemplary embodiment of the present invention.

Referring to FIG. 1, the LCD includes a liquid crystal panel 100, a driving voltage generator 200, a gate driver 300, a data driver 400, and a timing controller 500

As shown in FIG. 1, the liquid crystal panel 100 includes a plurality of pixels that are arranged in a matrix, which is electrically connected to a plurality of display signal lines G1-Gn and D1-Dm.

The display signal lines G1-Gn and D1-Dm comprise a plurality of gate lines G1-Gn that transmits gate signals, and a plurality of data lines D1-Dm that transmits data signals. The gate lines G1-Gn extend in a column direction and are substantially parallel to one another, and the data lines D1-Dm extend in a row direction and are substantially parallel to one another, Each of the plurality of pixels comprises a switching element M, which is electrically connected to a corresponding one of the plurality of display signal lines G1-Gn and D1-Dm, and a liquid crystal capacitor C_{LC}. Each of the plurality of pixels may include a storage capacitor C_{ST} that is electrically connected to the switching element M.

The switching element M is formed on a thin film transistor (TFT) substrate (not shown). The switching element M includes a control terminal which is electrically connected to the corresponding gate line, an input terminal which is electrically connected to the corresponding data line, and an output terminal which is electrically connected to the liquid crystal capacitor C_{Lc}and the storage capacitor C_{ST},

The liquid crystal capacitor C_{LC} includes a pixel electrode formed on the TFT substrate and a common electrode formed on a color filter substrate (not shown). A liquid crystal layer, as a dielectric material, is disposed between the pixel electrode and the common electrode. The pixel electrode is electrically connected to the switching element M. The common electrode may be formed on the entire surface of the color filter, and a common voltage VCOM is applied to the common electrode, The common electrode may be formed on the TFT substrate. The pixel electrode and the common electrode both may be stripe or bar shaped.

The storage capacitor C_{ST} may be formed by overlapping a separate signal line on the TFT substrate with the pixel electrode, and the common voltage VCOM is applied to the separate signal line (separate wire type), The storage capacitor C_{ST} may be formed by overlapping the pixel electrode with the common electrode (previous gate type) through an insulating material.

Each pixel can represent color to display a color image. To this end, a red (R), green (G), or blue (B) color filter may be disposed on a region on the color filter substrate corresponding to a pixel electrode or disposed above or below the pixel electrode on the TFT substrate.

A polarizer (not shown) polarizing light may be attached externally to either or both of the TFT substrate and the color filter substrate.

The driving voltage generator 200 produces a plurality of driving voltages. For example, the driving voltage generator 200 produces a gate-on voltage Von, a gate-off voltage Voff, and a common voltage VCOM.

The gate driver 300, which is electrically connected to the plurality of gate lines G1-Gn of the liquid crystal panel 100, applies external gate signals comprising a combination of the gate-on voltage Von and the gate-off voltage Voff to the gate lines G1-Gn.

The data driver 400, which is electrically connected to the plurality of data lines D1-Dm of the liquid crystal panel 100, may include a plurality of integrated circuits (iCs). The data driver 400 generates gray-scale voltages based on a plurality of differential gamma data supplied from a timing controller 500, which will be described later in this disclosure. The data driver 400 selects the generated gray-scale voltages, and applies the gray-scale voltages to each pixel as data signals.

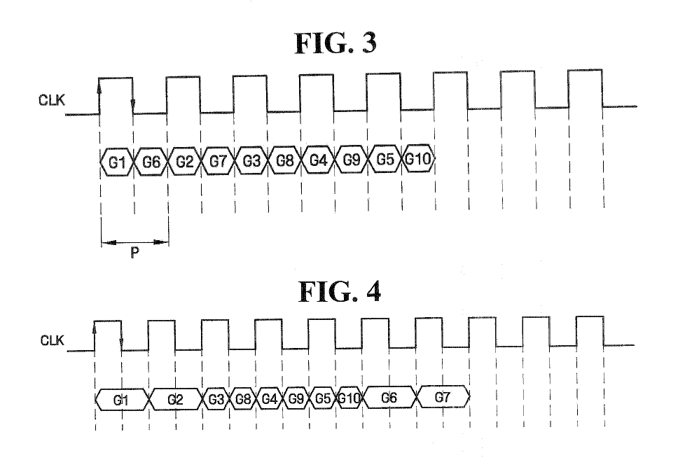

The timing controller 500 generates control signals for controlling operations of the gate driver 300 and data driver 400 and provides the corresponding control signals to the gate driver 300 and the data driver 400, respectively. In addition, the timing controller 500 provides the data driver 400 with differential gamma data Dgam, which will be described in detail with reference to FIG. 3.

Hereinafter, operations of the LCD will be described in detail.

The timing controller 500 receives R, G, and B image signals and input control signals controlling the display of the R, G, and B image signals, such as a vertical synchronization signal Vsync, a horizontal synchronization signal Hsync, main clock MCLK and data enable signal DE, from an external graphic controller (not shown). The timing controller 500 generates a gate control signal CONT1 and a data control signal CONT2 based on the input control signal, and processes the R, G, B image signals suitably according to the operation conditions of the liquid crystal panel 100. The timing controller 500 provides the gate control signal CONT1 to the gate driver 300 and the data control signal CONT2 and the resulting image signals R′, G′, and B′ to the data driver 400.

Here, the gate control signal CONT1 includes a vertical synchronization start signal STV for indicating the start of output of a gate-on pulse (gate-on voltage interval), a gate clock signal CPV for controlling the output time of the gate-on pulse and an output enable signal OE for defining the width of the gate-on pulse. The output enable signal OE and the gate crock signal CPV are provided to the driving voltage generator 200.

The data control signal C0N12 includes a horizontal synchronization signal STH for indicating the start of input of the image data R′, G′, and B′, a load signal LOAD for instructing application of the appropriate data voltages to the data lines D1-Dm, an inversion signal RVS for reversing the polarity of the data voltages with respect to the common voltage VCOM (hereinafter abbreviated as “the polarity of the data voltages”), and a data clock signal HCLK.

Although not shown as such, the differential gamma data Dgam may comprise a pair of gamma data associated with the transmittance of a unit pixel, including positive-polarity gamma data and negative-polarity gamma data. Positive- and negative-polarity gamma data refers to data having voltage polarities opposite to each other with respect to the common voltage VCOM and which are alternately supplied to the liquid crystal panel 100 during an a polarity inversion driving operation.

The data driver 400 sequentially receives image data R′, G′, and B′ corresponding to one row of unit pixels in response to the data control signal CONT2, which is received from the timing controller 500, and selects gray-scale voltages corresponding to the image data R′, G′ and B′ to convert the image data R′, G′, and B′ into data voltages selected among the gray-scale voltages.

The gate driver 300 sequentially applies a gate-on voltage Von to each of the plurality of gate lines G1-Gn in response to the gate control signal CONT1, which is received from the timing controller 500, to turn on the switching element M which is electrically connected to the gate line.

While the gate-on voltage Von is applied to one of the gate lines G1-Gn so that one row of switching elements Q that are electrically connected to the gate line are turned on (‘one horizontal period’ or ‘1H’). The data driver 400 applies each data voltage to a corresponding data line. The 1H is equal to one period of the horizontal synchronization signal Hsync, data enable signal DE, or gate clock signal CPV. The data voltage applied to the corresponding data line is then supplied to a corresponding pixel through the turned-on switching element M.

Molecule orientation in a liquid crystal device varies depending on the magnitude of the pixel voltage, and the molecular orientations determine the polarization of light passing through a liquid crystal layer (not shown). The change in polarization results in the change in the transmittance of light passing through a polarizer, which is disposed on the TFT substrate and the color filter substrate.

The gate-on voltage Von is sequentially applied to al of the gate lines GI-On during one frame, so that data voltages are applied to all the pixels. When the next frame starts after completing one frame, the inversion signal RVS applied to the data driver 400 may be controlled in such a way as to reverse the polarity of data voltages with respect to that of data voltages in the previous frame, which is called “frame inversion.” The inversion signal RVS may be controlled in such a way as to reverse the polarity of data voltages flowing in a data line in one frame according to characteristics of the inversion signal RVS, which is called “line inversion”. Or to reverse the polarity of the data voltages in one row of pixels, which is called “dot inversions”.

FIG. 2 illustrates how differential gamma data is transmitted from a timing controller to a data driver according to an exemplary embodiment of the present invention. FIGS. 3 and 4 are diagrams showing waveforms that correspond to differential gamma data transmitted according to an exemplary embodiment of the present invention.

Referring to FIG. 2; the timing controller 500 may include a memory (not shown) to store differential gamma data Dgam. The differential gamma data Dgam may be stored in a separately provided external memory (not shown). In an exemplary embodiment of the present invention, the external memory is an Electrically Erasable Programmable Read Only Memory (EEPROM). The differential gamma data Dgam may include Extended Display Identification Data (EDID) containing monitor information such as vendor, product ID code, and basic display parameters and characteristics, which may also be stored in the memory together with the differential gamma data Dgam.

The differential gamma data Dgam that is synchronized with a clock signal CLK, together with a pair of 5-bit positive and negative polarity gamma data, is transmitted to the first through sixth data drivers 410 through 460, respectively. The differential gamma data Dgam may be transmitted to the first through sixth data drivers 410 through 460 by LVDS (low voltage differential signaling) or RSDS (reduced swing differential signaling). It is to be understood that the number of the data drivers may vary depending on the resolution or size of an LCD.

In an exemplary embodiment of the present invention, LVDS is used when transmitting data from an external device to the display device and RSDS is used when transmitting data from the signal controller to the data driver disposed in the display device. In such a differential driving scheme, two signals having the same magnitude but opposite polarities are transmitted from transmitting terminals and are recognized by the differences in their levels at receiving terminals which may be located at both ends of the signal lines. Even when the voltage difference between the receiving terminals of the signal lines is small, data can be easily recognized, Since the RSDS scheme, in accordance with an exemplary embodiment of the present invention cancels out the electromagnetic wave occurring between signals having opposite polarities, the EMI is minimized, Further, because the data is recognized by the difference between the two signals, although noise may be present in the signal lines, there is almost no loss of data.

As shown in FIGS. 3 and 4, according to an exemplary embodiment of the present invention, a two data/clock transmission scheme is employed, in which two differential gamma data G1 and G6 are transmitted during one clock period (P). For example, the gamma data G1 is transmitted at the rising edge of a clock signal while the gamma data G6 is transmitted at the falling edge of the clock signal. As a result, the differential gamma data transmission according to an exemplary embodiment of the present invention enables a higher data rate than a conventional transistor-transistor logic (TTL) signal transmission methods and the number of transmission bus lines can be decreased, for example, by half the number of TTL data bus lines. The voltage for transmitting the differential gamma data Dgam may be in a range of about 1.0 V to about 1.2 V.

The differential gamma data Dgam supplied from the timing controller 500 may be transmitted to the data driver 400 using either a symmetric or an S asymmetric pattern. A desired pattern of the differential gamma data Dgam transmitted to the data driver 400 may be programmed on the timing controller 500. When a liquid crystal panel operates normally, the differential gamma data Dgam may be transmitted in a symmetric pattern. In cases when an after-image phenomenon or a distorted voltage, which is called a kickback voltage, occurs to the liquid crystal panel, the differential gamma data Dgam may be transmitted in an asymmetric pattern.

When the differential gamma data Dgam for example, 5 data bits, are transmitted in a symmetric pattern, as shown in FIG. 3, the positive-polarity gamma data G1 and the negative-polarity gamma data G6 may be simultaneously transmitted to the data driver 400. When the differential gamma data Dgam, for example, 7 data bits, are transmitted in an asymmetric pattern, as shown in FIG. 4, positive-polarity gamma data G1 and G2 or negative-polarity gamma data G6 and G7 may be transmitted independently to the data driver 400, or positive-polarity gamma data G3 and negative-polarity gamma data G8 may be simultaneously transmitted, Assuming that G1-G10 are differential gamma data used, G1, G2, G3, G4 and G5 denote positive-polarity gamma data, and G6, G7, G8: G9 and G10 denote negative-polarity gamma data, respectively.

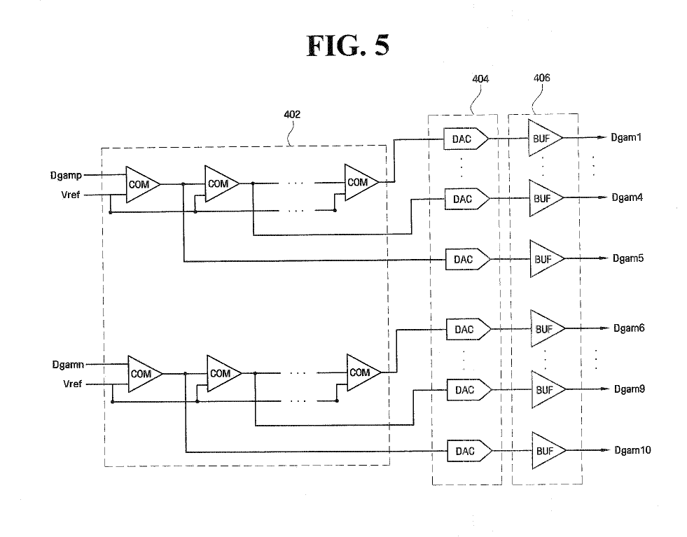

FIG. 5 is a block diagram of a data driver integrated circuit device according to an exemplary embodiment of the present invention.

Referring to FIG. 5, the data driver integrated circuit device includes a gamma decoding unit 402 decoding differential gamma data transmitted from the timing controller 500, a conversion unit 404 having a plurality of digital-to-analog converters (DACs) which are electrically connected to the gamma decoding unit 402, and a buffer unit 406 having a plurality of buffers (BUFs) which are electrically connected to the plurality of DACs.

The gamma decoding unit 402, which includes a plurality of comparators (COMs), receives positive-polarity gamma data Dgamp and negative-polarity gamma data Ddamn having voltage polarities opposite to each other and a reference voltage Vref. The gamma decoding unit 402 outputs decoded differential gamma data sequentially in an order in which the differential gamma data are applied to the data driver 400. In accordance with an exemplary embodiment of the present invention, when 5-bit differential gamma data are applied to the data driver 400, the gamma decoding unit 402 outputs decoded differential gamma data sequentially from G5 to G1. Here, the reference voltage Vref accurately adjusts analog data values and is set to about one half of a driving voltage AVDD. For example, when the first decoded differential gamma data applied to the gamma decoding unit 402 is 7.8 V, the reference voltage Vref is set to about 3.9 V. The reference voltage Vref may be implemented in the form of an internal resistance of the data driver integrated circuit device.

The plurality of DACs convert digital data transmitted from the gamma decoding unit 402 into analog voltage values, and the plurality of BUFs amplify the converted voltage values. The plurality of BUEs may be voltage followers. In an exemplary embodiment of the present invention, the total number of the analog voltage values is 10, including 5 positive-polarity analog voltage values and 5 negative-polarity analog voltage values. It is to be understood that the number of analog voltage values may vary according to input differential gamma data Dgam.

According to an exemplary embodiment of the present invention. differential gamma data are stored in a predetermined area of a memory the differential gamma data to be transmitted to a corresponding data driver integrated circuit device, thereby enabling an LCD to be driven without separately providing a gray-scale voltage generator, whereby a manufacturing cost of the LCD may be reduced.

According to an exemplary embodiment of the present invention, since a data driving integrated circuit device is constructed by additively providing decoders without using resistor terminals and operational amplifiers, simplifying the configuration of the overall circuitry, variations in the gamma voltage due to resistance differences may be prevented and the size of a PCB substrate may be reduced.

Although exemplary embodiments of the present invention have been described in detail with reference to the accompanying drawings for the purpose of illustration, it is to be understood that the inventive processes and apparatus should not be construed as limited thereby. It will be readily apparent to those of reasonable skill in the art that various modifications to the foregoing exemplary embodiments can be made without departing from the scope of the invention as defined by the appended claims, with equivalents of the claims to be included therein.

What is claimed is:

1. A data driver integrated circuit device comprising:
a gamma decoding unit receiving differential gamma data transmitted by a timing controller and decoding the received differential gamma data;
a digital-to-anatog conversion (DAC) unit converting the decoded differential gamma data into analog voltage values; and
a buffer unit amplifying the analog voltage values, and outputting the amplified values.

2. The data driver integrated circuit device of claim 1, wherein the gamma decoding unit receives the differential gamma data and a reference voltage, and outputs the decoded differential gamma data sequentially in an order in which the differential gamma data are applied to the data driver using a plurality of comparators.

3. The data driver integrated circuit device of claim 1, wherein the reference voltage is set to about one half of a driving voltage.

4. The data driver integrated circuit device of claim 1, wherein the reference voltage is implemented in a form of an internal resistance.

5. The data driver integrated circuit device of claim 1, wherein the differential gamma data includes positive-polarity gamma data and negative-polarity gamma data.

6. A liquid crystal display (LCD) comprising:
a liquid crystal panel including a plurality of thin film transistors (TFTs), a plurality of gate lines electrically connected to gate electrodes of the plurality of TFTs, and a plurality of data lines electrically connected to source electrodes of the plurality of TFTs; and
a timing controller generating control signals that control operations of a gate driver and a data driver integrated circuit device and provide the data driver with differential gamma data,
wherein the data driver integrated circuit device converts the differential gamma data into analog voltage values, and applies the converted values to the plurality of data lines of the liquid crystal panel.

7. The LCD of claim 6, Wherein the data driver integrated circuit device comprises:
a gamma decoding unit receiving and decoding the differentiate gamma data transmitted by the timing controller;
a digital-to-analog conversion (DAC) unit converting the decoded differential gamma data into analog voltage values; and
a buffer unit amplifying the analog voltage values and outputting the amplified values.

8. The LCD of claim 7, wherein the gamma decoding unit receives the differential gamma data and a reference voltage, and outputs the decoded differential gamma data sequentiality in an order in which the differential gamma data are applied to the data driver, and wherein the gamma decoding unit includes a plurality of comparators.

9. The LCD of claim 8, wherein the reference voltage is set to about one half of a driving voltage.

10. The LCD of claim 8, wherein the reference voltage is implemented in a form of an internal resistance.

11. The LCD of claim 6, wherein the differential gamma data is stored in an internal memory of the timing controller.

12. The LCD of claim 6, wherein the differential gamma data is stored in a memory provided externally to the timing controller.

13. The LCD of claim 12, wherein the memory is an EEPROM (Electrically Erasable and Programmable Read-Only Memory).

14. The LCD of claim 6, wherein the differential gamma data is transmitted to the data driver integrated circuit device using an LVUS (low voltage differential signaling) method.

15. The LCD of claim 6, wherein the differential gamma data is transmitted to the data driver integrated circuit device using an RSDS (reduced swing differential signaling) method.

16. The LCD of claim 6, wherein the differential gamma data is transmitted to the data driver integrated circuit device using either a symmetric or an asymmetric pattern.

17. The LCD of claim 16, wherein when the differential gamma data is transmitted using a symmetric pattern, and positive-polarity gamma data and negative-polarity gamma data are substantially simultaneously transmitted.

18. The LCD of claim 16, wherein when the differentiate gamma data is transmitted using the asymmetric pattern, either positive-polarity gamma data or negative-polarity gamma data is independently transmitted, or positive-polarity gamma data and negative-polarity gamma data are substantially simultaneously transmitted.

19. A method of data driving of a display, comprising:
receiving differential gamma data transmitted by a timing controller;
decoding the received differential gamma data;
converting the decoded differential gamma data into analog voltage values; and
amplifying the analog voltage values and outputting the amplified values.
